(19) United States
(12) Patent Application Publication
(10) Pub. No.: US 2003/0217361 A1
(43) Pub. Date: Nov. 20, 2003

(54) Carrier monitor system and method

(76) Inventors: John J. LoMonaco, Greentown, PA (US); David H. McDowell, Honesdale, PA (US)

Correspondence Address: Joyce Kosinski, Loral Space and Communications, Ltd., 655 Deep Valley Drive, Suite 303, Rolling Hills Estates, CA, 90274, US

(21) Appl. No.: 10/141,367

(22) Filed: May 8, 2002

(51) Int. Cl. H04H 1/00; H04N 7/20

(52) U.S. Cl. 725/63; 455/3.02

(57) ABSTRACT

Systems and methods that monitor part-time transponder usage in real time. A satellite carries one or more part-time usage transponders and a ground station communicates with the transponders. A satellite receiver at the ground station processes transponder signals to output a baseband video signal when present and a noise signal when the video signal is not present. An integrated receiver-decoder at the ground station processes the transponder signal to output an analog video signals comprising constant video black line, synchronization, tip and color burst signals, when no signal is present at the input thereof. A circuit processes signals output by the satellite receiver and integrated receiver decoder to sense the presence of a valid NTSC vertical interval synchronizing pulse to detect the presence of an analog video signal, sense an average picture level signal to detect the presence of a digital video signal, sense the noise signal to detect the presence of a carrier signal output an alarm signal when the peak video level of the average picture level signal falls below a predetermined level, indicating that no digital video signal is present, and output an alarm signal when the noise signal is present, indicating that no carrier signal is present. A computer comprising a database and software processes and stores data comprising the alarm signals, a date and time stamp, and information identifying the associated satellite and transponder in the database, and is used to process the information in the database to monitor usage of part-time transponders.

### BACKGROUND

The present invention relates generally to satellite communication systems and methods, and more particularly, to a carrier monitor system and method for use with satellite communication systems.

The assignee of the present invention operates communication satellites that provide global communication services. Each of the communication satellites include transponders that provide communication channels between Earth terminals and/or ground stations.

Some of the transponders on satellites are used on a part-time basis by customers. Typically, transponder time is booked or ordered based upon 30 minute intervals, for example. Determining transponder usage end times sometimes cannot be provided due to the large number of transponders and relatively few communication technicians required to monitor them. Monitoring thirty-two (32) transponders is physically impossible for a single human operator.

An “Approx. Out” is referred to as a time when an estimated time order reserved for a customer will end. For example, if a customer has a start time of 08:00 AM and a 10:00 AM end time with a 30 minute Approx. Out, the end time for transponder usage can be less than, but not greater than 10:30 AM. The estimated amount of lost transponder time is on the order of 15 percent.

Thus, because of this variability in transponder usage end times, there is a loss of billing time for the use of part-time transponders. In 1999, for example, the operations center of the assignee of the present invention determined that there were 1,864 Approx. Outs, which resulted in a significant loss of revenue and inefficient transponder usage. The present invention is designed to help recapture this lost time.

In addition, there are other factors that relate to part-time transponder usage. These factors other include delays of service, accurate log entries, and proper billing. These other factors also cause inefficiencies in operations.

It is therefore an objective of the present invention to provide for an improved carrier monitor system and method for monitoring part-time satellite transponder usage in real time.

### SUMMARY OF THE INVENTION

To accomplish the above and other objectives, the present invention is a carrier monitor system and method that monitors part-time transponder usage in real time. The carrier monitor system includes a receive antenna that receives analog, video and carrier signals transmitted from transponders onboard a satellite. The receive antenna is coupled to a satellite receiver and to an integrated receiver decoder (IRD). The satellite receiver and integrated receiver decoder are coupled to a selected number of video processing boards that are each constructed in accordance with the present invention.

The satellite receiver outputs modulated and unmodulated output signals when a signal is received and outputs noise when no signal is present. The integrated receiver decoder outputs modulated signals when the signal is received. The modulated signals include constant video black line, synchronization, tip and color burst signals when no signal is present. When a signal is present, the integrated receiver decoder outputs video information above 10 IRE.

Each of the video processing boards process modulated and unmodulated output signals output by the receiver and integrated receiver decoder and outputs TTL digital signals. The video processing boards are coupled by way of an interface hub to a computer. The computer implements a software program comprising a database implemented in accordance with the present invention. The software program processes the TTL digital signals to monitor the part-time transponder usage.

In accordance with the present invention, the system detects the presence of analog video signals using synchronization signals. In accordance with the present invention, the system uses average picture level (APL) detection to detect the digital signals after demodulation of signals output by the integrated receiver demodulator (IRD). Furthermore, in accordance with the present invention, the system detects the carrier signal using the noise of the satellite receiver with the absence of a signal or carrier.

The present system optionally provides for alert/caution flags for orders running past their window or in their Approx. Out time. High alert flags may also be provided that prevent outages and delays of service.

### BRIEF DESCRIPTION OF THE DRAWINGS

The various features and advantages of the present invention may be more readily understood with reference to the following detailed description taken in conjunction with the accompanying drawing, wherein like reference numerals designate like structural elements, and in which:

FIG. 1 illustrates an exemplary satellite communication system in which the present invention is employed;

FIG. 2 illustrates an exemplary embodiment of a system in accordance with the principles of the present invention that may be used with the communication system shown in FIG. 1;

FIG. 3 illustrates an exemplary communication method in accordance with the principles of the present invention; and

FIG. 4 is a flow chart that illustrates an exemplary event date and time stamping algorithm (method or software) in accordance with the principles of the present invention.

### DETAILED DESCRIPTION

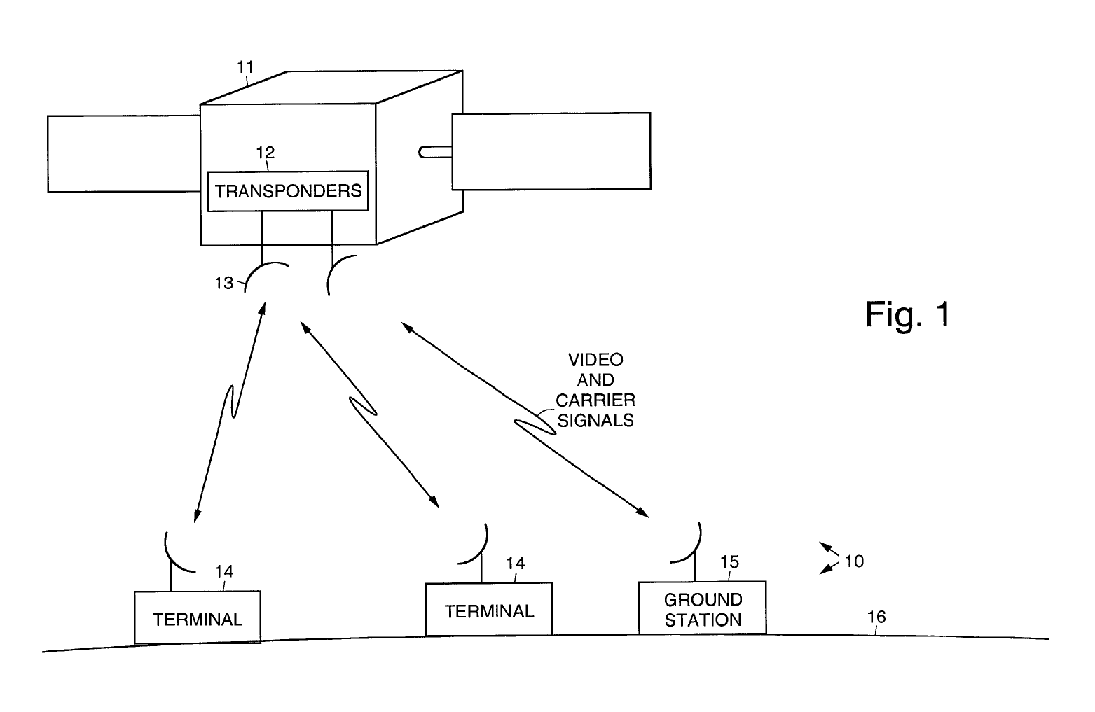

Referring to the drawing figures, FIG. 1 illustrates an exemplary satellite communication system 10 in which the present invention is employed. The exemplary satellite communication system 10 comprises a satellite 11 that carries a plurality of transponders 12 that communicate by way of communication antennas 13 with terminals 14 and/or ground stations 15 on the Earth 16.

The transponders 12 are allocated to customers on a full-time or part-time usage basis. The customers purchase usage time for each transponder 12. The present invention was developed in order to use transponders 12 that are used on a part-time basis in the most efficient manner.

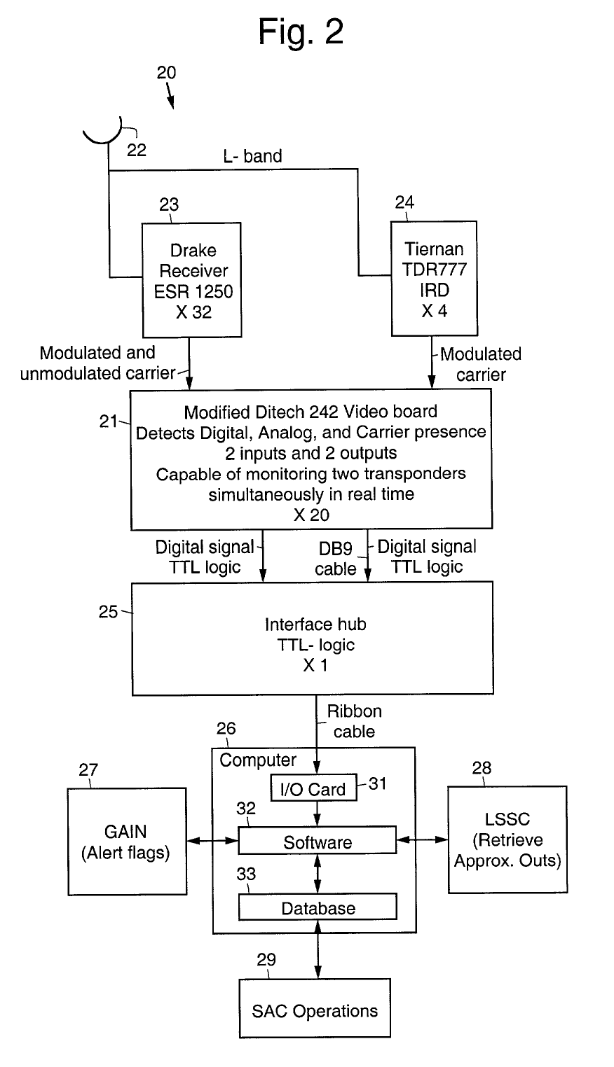

FIG. 2 illustrates an exemplary embodiment of a carrier monitor system 20 in accordance with the principles of the present invention that may be used with the communication system 10 shown in FIG. 1. The carrier monitor system 20 is preferably employed in a selected ground station 15 operated by the assignee of the present invention.

As is shown in FIG. 2, the carrier monitor system 20 comprises a receive antenna 22 at the ground station 15 that receives analog, video and carrier signals transmitted from a transponder 12 onboard the satellite 11. The receive antenna 22 is coupled to a satellite receiver 23 and to an integrated receiver-decoder (IRD) 23. The satellite receiver 23 may be Drake model ESR 1250 receiver 23, for example. The integrated receiver-decoder 24 may be a Tiernan model TDR777 integrated receiver-decoder 24, for example. In a reduced-to-practice embodiment of the carrier monitor system 20, thirty-two satellite receivers 23 and four integrated receiver-decoders 24 are employed.

The satellite receiver 23 processes signals derived from the transponder 12 to output modulated and unmodulated signals. In particular, the satellite receiver 23 outputs a baseband analog video signal when present at its input and a noise signal when a signal is not present at its input.

The integrated receiver-decoder 24 processes signals derived from the transponder 12 to output modulated signals. In particular, the integrated receiver-decoder 24 outputs video information above 10 IRE when a signal is present at its input. The integrated receiver-decoder 24 outputs analog video signals comprising constant video black line, synchronization, tip and color burst signals, when no signal is present at its input.

The satellite receiver 23 and integrated receiver-decoder 24 are respectively coupled to video detection circuitry 21 that comprises a plurality of video processing boards 21 that are each constructed in accordance with the principles of the present invention. The video detection circuitry 21 receives signals from the satellite receiver 23 and the integrated receiver-decoder 24.

The reduced-to-practice embodiment of the video detection circuitry 21 includes twenty video detection circuit boards 21, such as Ditech model 242 video detection circuit boards 21 that have been modified in accordance with the principles of the present invention. Each video detection circuit board 21 has two inputs and two outputs and is capable of simultaneously monitoring two transponders 12 in real time.

Each video detection circuit board 21 comprising the video detection circuitry 21 is coupled to an interface hub 25 that provides an interface between the video detection circuitry 21 and a computer 26. The computer 26 has an addressable input-output card 31, such as a National Instruments 96 pin addressable I/O card 31, for example, that interfaces with the interface hub 25 using a ribbon cable, for example. The computer 26 includes software 32 and at least one database 33 in accordance with the present invention. The database 33 has database entries at least including year, month, day, event type and time.

Video signal detection has been around for a long time. However, in accordance with the present invention, the carrier monitor system 20 detects the presence of analog video signals using synchronization signals. The Ditech video boards 21 have been modified in accordance with the present invention to detect the presence of analog video signals using synchronization signals.

The carrier monitor system 20 also uses average picture level (APL) detection to detect the digital signals after demodulation of signals output by the integrated receiver-decoder 24, and detects the carrier signal using the noise of the satellite receiver 23 with the absence of a signal or carrier. The Ditech video boards 21 have been modified in accordance with the present invention to implement the average picture level and carrier signal detection features of the present invention.

The carrier monitor system 20 also provides addressable date and time stamping of events, and provides for alert/caution flags for orders running past their window or in their Approx. Out time. The carrier monitor system 20 also provides high alert flags that prevent outages and delays of service.

The present digital/analog carrier monitor system 20 aids the twenty-six (26) responsibilities of technicians to monitor Approx. Outs of the transponders 12 on the satellite 11. By accurately logging entries of part-time usage transponders 12 in real time, lost time due to Approx. Outs is substantially eliminated using the present invention.

The carrier monitor system 20 monitors video and carrier presence in real time, using the modified video boards 21. As a video/carrier signal is detected, a TTL signal is sent through the interface hub 25 to the addressable I/O card 31 in the computer 26. The video/carrier signal is linked or input to the software 32 which processes the signal to monitor usage of the transponders 12. The primary function of the software 32 is to date and time stamp the video/carrier signals.

An optional “GAIN” software module 27 may be used with the carrier monitor system 20 to provide caution/red alert flags. The use of the GAIN software module 27 is designed to reduce the amount of interference and delays of service. In doing so, the GAIN software module 27 creates accurate log entries, which may be used for proper billing of Approx. Out orders. An optional “LSSC” software module 28 may be used with the carrier monitor system 20 to retrieve the Approx. Outs of the transponders 12.

“Remedy” is a database that is used in a reduced-to-practice embodiment of the carrier monitor system 20 into which communication technicians input information regarding date, time, uplinker, customer and transponder 12, when uplinkers call in to access the satellite 11. “CMS” is a database 33 used by the assignee of the present invention where the carrier monitor system 20 automatically records information regarding transponder 12, event type, time, day, month and year. Two exemplary Remedy databases 33 are shown in Tables 1 and 3 below. Two corresponding CMS databases 33 are shown in Tables 2 and 4 below.

TABLE 1
Matching Uplink Activity (videoa)

| Entry-Id | Date: | Start Time | Customer: | Uplink: | SATXPE | SAT: | XPDR: |
|---|---|---|---|---|---|---|---|
| 523176 | 9/4/00 00: | 0647 | GCAST | TPLA | T4C6 | T4 | C06 |
| 523183 | 9/4/00 00: | 0821 | GCAST | TPLA | T4C6 | T4 | C06 |
| 523200 | 9/4/00 00: | 0955 | GCAST | ATCNJ | T4C6 | T4 | C06 |
| 523256 | 9/4/00 00: | 1509 | GCAST | WITF | T4C6 | T4 | C06 |
| 523428 | 9/4/00 00: | 1600 | GCAST | GCASTN | T4C6 | T4 | C06 |

TABLE 2

| | EVENT | | | DATE | TIME |
|---|---|---|---|---|---|
| XPONDER | TYPE | DATE ON | TIME ON | OFF | OFF |
| 6 | CAR | 09/04/00 | 06:47:45 | 09/04/00 | 06:48:19 |
| 6 | VID | 09/04/00 | 06:48:20 | 09/04/00 | 08:01:26 |
| 6 | CAR | 09/04/00 | 08:23:03 | 09/04/00 | 08:23:15 |
| 6 | VID | 09/04/00 | 08:23:16 | 09/04/00 | 09:31:07 |
| 6 | CAR | 09/04/00 | 15:11:14 | 09/04/00 | 15:11:28 |
| 6 | VID | 09/04/00 | 15:11:29 | 09/04/00 | 15:30:51 |
| 6 | CAR | 09/04/00 | 15:30:51 | 09/04/00 | 15:30:58 |
| 6 | CAR | 09/04/00 | 15:38:48 | 09/04/00 | 15:38:58 |
| 6 | VID | 09/04/00 | 15:38:59 | 09/04/00 | 16:01:08 |
| 6 | VID | 09/04/00 | 16:01:15 | 09/04/00 | 16:16:18 |

TABLE 3
Matching Uplink Activity (videoa)

| Entry-Id | Date: | Start Time | Customer: | Uplink: | SATXPE | SAT: | XPDR: |
|---|---|---|---|---|---|---|---|
| 523587 | 9/5/00 00: | 0635 | GCAST | CBSH | T4C6 | T4 | C06 |
| 523606 | 9/5/00 00: | 0948 | GCAST | GCASTN | T4C6 | T4 | C06 |
| 523728 | 9/5/00 00: | 1520 | GCAST | GCASTS | T4C6 | T4 | C06 |
| 523753 | 9/5/00 00: | 1546 | GCAST | GCASTN | T4C6 | T4 | C06 |
| 523799 | 9/5/00 00: | 1747 | GCAST | KNME | T4C6 | T4 | C06 |
| 523803 | 9/5/00 00: | 1817 | GCAST | GCASTN | T4C6 | T4 | C06 |

TABLE 4

| XPONDER | EVENT TYPE | DATE ON | TIME ON | DATE OFF | TIME OFF |
|---|---|---|---|---|---|
| 6 | VID | Sep. 05, 2000 | 06:36:51 | Sep. 05, 2000 | 08:00:18 |
| 6 | VID | Sep. 05, 2000 | 08:22:45 | Sep. 05, 2000 | 09:30:26 |
| 6 | CAR | Sep. 05, 2000 | 09:49:55 | Sep. 05, 2000 | 09:50:03 |
| 6 | VID | Sep. 05, 2000 | 09:50:04 | Sep. 05, 2000 | 10:31:16 |
| 6 | VID | Sep. 05, 2000 | 12:50:44 | Sep. 05, 2000 | 13:21:33 |
| 6 | CAR | Sep. 05, 2000 | 15:20:42 | Sep. 05, 2000 | 15:20:56 |
| 6 | VID | Sep. 05, 2000 | 15:20:56 | Sep. 05, 2000 | 15:46:14 |
| 6 | VID | Sep. 05, 2000 | 15:47:40 | Sep. 05, 2000 | 17:31:17 |
| 6 | CAR | Sep. 05, 2000 | 17:45:37 | Sep. 05, 2000 | 17:48:06 |
| 6 | VID | Sep. 05, 2000 | 17:48:07 | Sep. 05, 2000 | 18:15:56 |
| 6 | VID | Sep. 05, 2000 | 18:18:26 | Sep. 05, 2000 | 22:10:27 |

During operation of the carrier monitor system 20, a video/carrier signal received at the receive antenna 22 is sent through several devices (not shown) that operate at L-band frequencies. The L-band frequency signals are then input to the satellite receivers 22 (Drake ESR 1450) and integrated receiver-decoders 23 (Tiernan TDR777 IRD). Carrier and video detection using the carrier monitor system 20 then starts.

The satellite receivers 22 and integrated receiver-decoders 23 process the L-band frequencies for usable baseband frequencies, which are approximately 0 to 5 MHz of analog video information—100/40 IRE (NTSC). When the satellite receivers 23 are not detecting an analog video signal, they have a constant output of approximately 800 mV of random noise. These signals (video or noise) are sent via coax cables to the video boards 21. The noise is used for detection of the carrier signals. The integrated receiver-decoders 24 output analog video signals including constant video black line, synchronization, tip and color burst signals, when no signal is present at the input thereof. These signals are then sent via coax cables to the video boards 21.

A video board 21 is dedicated to a satellite receiver 23. The output of the satellite receivers 23 is processed by the video board 21. The video board 21 has three different detectors. The first detector senses the presence of valid NTSC vertical interval synchronizing pulses, and detects analog video presence.

The second detector is an average picture level (APL) detector. When the peak video level falls below a preset of 10 IRE, an alarm is triggered. The second detector is used to detect the presence of digital video signals.

The third detector is used to detect the presence of a carrier signal. The lack of a signal into the receiver 23 causes the output of the receiver 23 to be a noisy signal. This noise is used to trigger the alarm. The alarm signals output by the video board 21 are input to the database 33 along with a date and time stamp and information identifying the associated satellite 11 and transponder 12. The outputs of the video board 21 are TTL signals, active low. The TTL signals are sent by way of DB9 and ribbon cables to the input of the addressable I/O card 31.

The addressable I/O card 31 functions to address each input signal and convert each electrical signal into a signal that is input to the database 33. The database 33 sorts information by satellite, transponder, year, month, day and time. The database 33 records the date and time stamping of the detected signals.

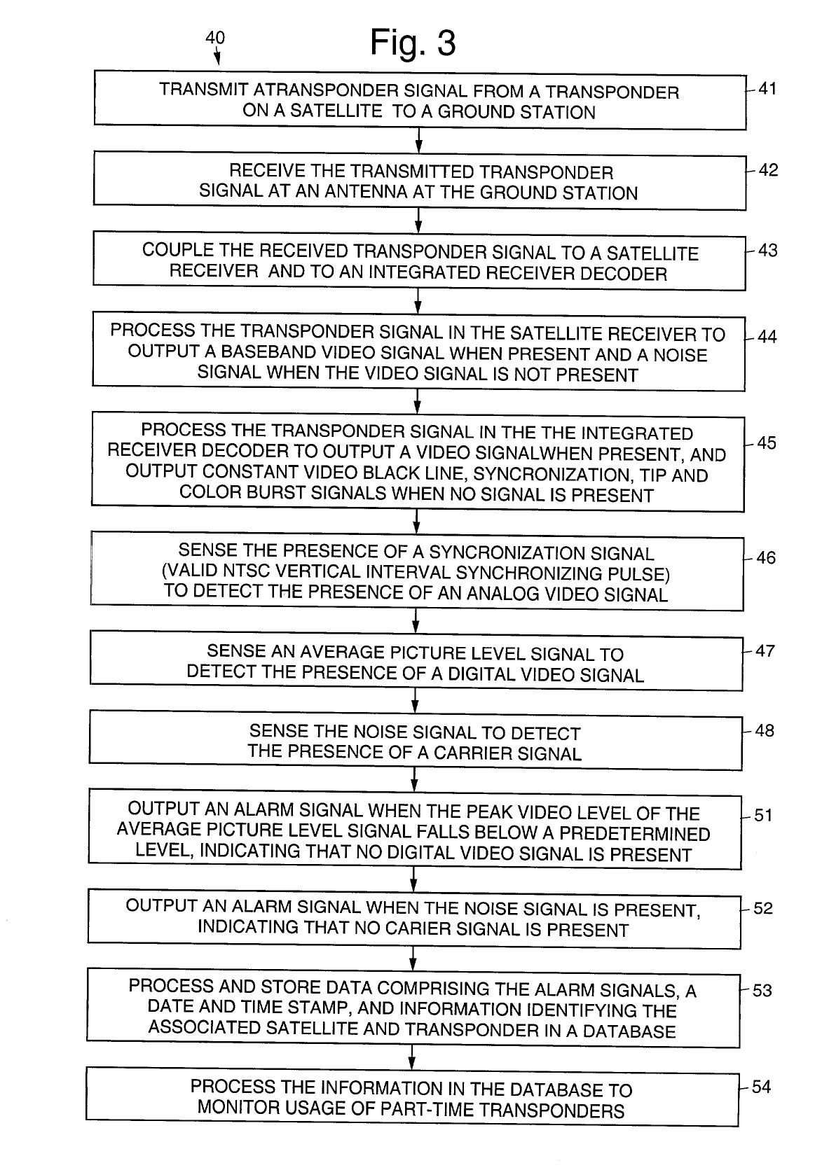

FIG. 3 illustrates an exemplary communication method 40 in accordance with the principles of the present invention. The exemplary method 40 communication comprises the following steps.

A transponder signal is transmitted 41 from a transponder 12 on a satellite 11 to a ground station 15. An antenna 22 at the ground station 15 receives 42 the transmitted transponder signal. The received transponder signal is coupled 43 to a satellite receiver 23 and to an integrated receiver-decoder 24. The satellite receiver 23 processes the transponder signal and outputs 44 a baseband video signal when present and a noise signal when the video signal is not present. The integrated receiver-decoder 24 processes the transponder signal and outputs 45 analog video signals comprising constant video black line, synchronization, tip and color burst signals, when no signal is present at the input thereof.

Signals from the satellite receiver 23 and integrated receiver-decoder 24 are processed to sense the presence of a valid NTSC vertical interval synchronizing pulse to detect 46 the presence of an analog video signal, sense an average picture level signal to detect 47 the presence of a digital video signal, and sense the noise signal to detect 48 the presence of a carrier signal. An alarm signal is output 51 when the peak video level of the average picture level signal falls below a predetermined level, indicating that no digital video signal is present. An alarm signal is output 52 when the noise signal is present, indicating that no carrier signal is present. Data comprising the alarm signals, a date and time stamp, and information identifying the associated satellite 11 and transponder 12 are processed and stored 53 in a database 33. The information in the database 33 is processed 54 to monitor usage of part-time transponders 12.

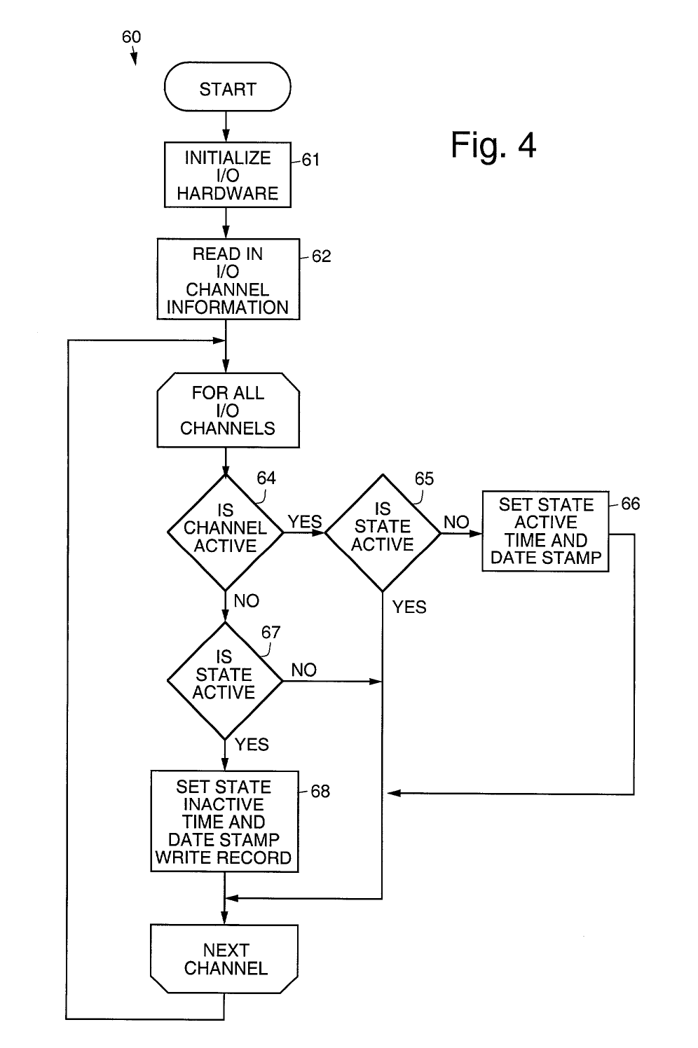

FIG. 4 is a flow chart that illustrates an exemplary event date and time stamping algorithm 60 (method 60 or software 60) in accordance with the principles of the present invention. The exemplary event date and time stamping algorithm 60 comprises the following steps.

The algorithm 60 (method 60 or software 60) starts and initializes 61 input/output (I/O) channels. Then, I/O channel information is read 62. An iterative process is performed for each of the channels.

For each (all) I/O channels, it is determined 64 if the channel is active. If the channel is active (Yes), it is determined 65 if the state of the channel is active. If the state of the channel is not active (No), the state is set to active and a time and date stamp is generated 66. Once the channel is time and dated stamped 66, the next channel is processed. If it is determined 65 that the state of the channel is active (Yes), the next channel is processed.

If it is determined 64 that the channel is not active (No), it is determined 67 if the state of the channel is active. If it is determined 67 that the state of the channel is not active (No), the next channel is processed. If it is determined 67 that the state of the channel is active (Yes), the state is set to inactive, a time and date stamp is generated, and the record is recorded 68. Then, the next channel is processed.

Thus, the present invention logs real time entries, and provides date and time stamping of received transponder signals. In particular, the present invention monitors part-time transponders 12 simultaneously in real time. The present invention provides analog, average picture level (APL) and carrier detection. Transponder events are logged in the database 33 by year, month, day, event type and time, which are preferably listed in alphanumeric order. The present invention processes the events to provide outputs that warn of possible conflicts and prevents or minimizes service delays and outages. The present invention logs start and end times with a high degree of accuracy and increases the efficiency of operations.

Thus, a carrier monitor system and method for use with satellite communication systems have been disclosed. It is to be understood that the above-described embodi- ments are merely illustrative of some of the many specific embodiments that represent applications of the principles of the present invention. Clearly, numerous and other arrangements can be readily devised by those skilled in the art without departing from the scope of the invention.

What is claimed is:

1. A carrier monitor system, comprising:
a satellite carrying one or more part-time usage transponders;
a ground station for communicating with the transponders;
a satellite receiver at the ground station for processing transponder signals to output a baseband analog video signal when present, and a noise signal when the video signal is not present;
an integrated receiver-decoder at the ground station for processing the transponder signals to output a video signal when present, and analog video signals comprising constant video black line, synchronization, tip and color burst signals, when no video signal is present;
a video detection circuit for processing signals from the satellite receiver and integrated receiver decoder to sense the presence of a valid NTSC vertical interval synchronizing pulse to detect the presence of an analog video signal, sense an average picture level signal to detect the presence of a digital video signal, sense the noise signal to detect the presence of a carrier signal output an alarm signal when the peak video level of the average picture level signal falls below a predetermined level, indicating that no digital video signal is present, and output an alarm signal when the noise signal is present, indicating that no carrier signal is present; and
a computer comprising a database and software for processing and storing data comprising the alarm signals, a date and time stamp, and information identifying the associated satellite and transponder in the database, and for processing the information in the database to monitor usage of part-time transponders.

2. The carrier monitor system recited in claim 1 further comprising an interface hub coupled between the video detection circuit and the computer.

3. The carrier monitor system recited in claim 2 wherein the computer comprises an input-output card coupled to the interface hub.

4. A method for monitoring usage of part-time transponders on a satellite, comprising:
transmitting a transponder signal from a transponder on the satellite to a ground station;
receiving the transmitted transponder signal at the ground station;
coupling the received transponder signal to a satellite receiver and to an integrated receiver-decoder;
processing the transponder signal in the satellite receiver to output a baseband analog video signal when present and a noise signal when the video signal is not present;
processing the transponder signal in the integrated receiver decoder to output an analog video signals comprising constant video black line, synchronization, tip and color burst signals, when no signal is present at the input thereof;
processing signals from the satellite receiver and integrated receiver decoder to sense the presence of a valid NTSC vertical interval synchronizing pulse to detect the presence of an analog video signal, sense an average picture level signal to detect the presence of a digital video signal, and sense the noise signal to detect the presence of a carrier signal;
outputting an alarm signal when the peak video level of the average picture level signal falls below a predetermined level, indicating that no digital video signal is present;
outputting an alarm signal when the noise signal is present, indicating that no carrier signal is present;
processing and storing data comprising the alarm signals, a date and time stamp, and information identifying the associated satellite and transponder in a database; and
processing the information in the database to monitor usage of part-time transponders.

5. An algorithm for providing event date and time stamping to monitor usage of part-time transponders on a satellite, comprising:
initializing input/output channels for the part-time transponders;
reading input/output channel information of the part-time transponders;
performing the following steps for each of the channels:
determining if the channel is active;
if the channel is active, determining if the state of the channel is active;
if the state of the channel is not active, setting the state to active and generating a time and date stamp;
processing the next channel once the channel is time and dated stamped;
if the state of the channel is active, processing the next channel;
if channel is not active, determining if the state of the channel is active;
if the state of the channel is not active, processing the next channel; and
if the state of the channel is active, setting the state to inactive, generating a time and date stamp, and recording the record.
